(19) United States
(12) Patent Application Publication
(10) Pub. No.: US 2003/0117435 A1
(43) Pub. Date: Jun. 26, 2003

(54) Profile creating system

(76) Inventors: Naoko Hiramatsu, Kyoto-Shi (JP); Motohiro Asano, Osaka (JP); Fumiko Uchino, Otokuni-Gun (JP)

Correspondence Address: BURNS, DOANE, SWECKER & MATHIS, L.L.P., P.O. Box 1404, Alexandria, VA, 22313-1404, US

(21) Appl. No.: 10/323,937

(22) Filed: Dec. 20, 2002

(30) Foreign Application Priority Data
Dec. 26, 2001 (JP) P2001-394078

(51) Int. Cl. G09G 5/00

(52) U.S. Cl. 345/745

(57) ABSTRACT

A profile creating system has, as profile creating modes, a display mode for the purpose of creating a profile of a display and a printer mode for the purpose of creating a profile of a printer, and one of the modes can be selected. In the display mode, the screen of the display displaying a predetermined reference image is captured by a digital camera, and a computer creates a profile on the basis of the captured image. On the other hand, in the printer mode, a predetermined reference image is printed by the printer, the printed image is photographed by the digital camera, and the computer creates a profile on the basis of the captured image. In such a manner, both of a profile of the display and that of the printer can be created at low cost.

This application is based on application No.2001-394078 filed in Japan, the contents of which are hereby incorporated by reference.

### BACKGROUND OF THE INVENTION

1. Field of the Invention

The present invention relates to a technique of creating a profile for correcting colors.

2. Description of the Background Art

When a color image is displayed on a display or printed by a printer, due to different characteristics of devices, a color to be reproduced of the same image data may vary.

In recent years, as a technique for matching colors of devices, a color management system (CMS) has been proposed. In a general color management system, color matching among devices is performed by storing a profile (for example, ICC profile) indicative of the color characteristic of each of devices in a computer or the like controlling the devices and correcting the colors of images by using the profile.

As the color characteristic of a device changes with time according to frequency of use and the like, in order to properly perform such color matching, profiles of devices have to be properly created.

For example, a profile of a display is created by measuring a color image as a reference displayed on the display by a dedicated measuring device and processing the result of measurement by a computer which executes a dedicated program.

A profile of a printer is created by printing a color image as a reference by the printer, measuring the result of printing by a dedicated measuring device, and processing the result of measurement by a computer which executes a dedicated program.

The dedicated measuring devices and programs for creating profiles of such devices are very expensive. In addition, since an object to be measured in a display is an emitter and an object to be measured in a printer is a reflector, it is difficult to create profiles of the display and printer by using the same measuring device and the same program.

Consequently, a problem such that the profile creating cost is high arises, and general users cannot easily introduce a dedicated profile creating system.

### SUMMARY OF THE INVENTION

The present invention is directed to a program product comprising a computer executable program for creating a profile.

According to the present invention, the computer executable program comprises: a selecting instruction for selecting one of a first processing mode and a second processing mode; a first profile creating instruction operable in the first processing mode to create a profile of a display based on a first captured image obtained by capturing a predetermined first reference image displayed on the display by using a digital image capture device; and a second profile creating instruction operable in the second processing mode to create a profile of a printer based on a second captured image obtained by capturing an image of a printed matter printed by a printer in accordance with a predetermined second reference image by using the digital image capture device.

Both of the profile of the display and the profile of the printer can be created at low cost.

In an aspect of the present invention, the computer executable program further comprises: an image capture device control instruction for controlling image capturing of the digital image capture device in accordance with a processing mode selected by the selecting part.

An image required to create a profile can be easily obtained according to the processing mode.

In another aspect of the present invention, the image capture device control instruction is operable in the first processing mode to control the digital image capture device so as to perform exposure for a time determined based on a screen updating period of the display when the digital image capture device captures the first reference image.

The first reference image is captured by performing exposure for a time determined based on the screen updating period of the display, color unevenness which occurs in the first captured image can be reduced.

In another aspect of the present invention, the image capture device control instruction is operable in the second processing mode to control the digital image capture device so as to achieve an exposure condition which suppresses an incident light amount and to allow flashlight to be emitted toward the printed matter when the digital image capture device captures the printed matter, and the second profile creating instruction is operable in the second processing mode to obtain object color component data corresponding to data of an image from which an influence of an illumination environment is removed based on the second captured image and a relative spectral distribution of the flashlight, and to create a profile of the printer based on the object color component data.

The profile of the printer is crated based on the object color component data. Thus, the profile of the printer can be created with high precision.

The present invention is also directed to a profile creating system for creating a profile.

The present invention is also directed to a method of creating a profile.

Accordingly, it is an object of the present invention to provide a technique capable of creating both a suitable profile of a display and a suitable profile of a printer at low cost, by using a digital image capture device.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the configuration of a profile creating system according to a preferred embodiment of the present invention;

FIG. 2 is a block diagram showing main internal components of a computer;

FIG. 3 is a block diagram showing main internal components of a digital camera;

FIG. 4 is a block diagram showing the functional configuration of the computer together with the other components;

FIG. 5 is a diagram showing the outline of the flow of a profile creating system;

FIG. 6 is a diagram showing the flow of a profile creating process in a display mode;

FIG. 7 is a perspective view showing an example of the layout of the profile creating system in the display mode;

FIG. 8 is a block diagram showing the functional configuration of a first profile creating unit;

FIG. 9 is a diagram showing an example of a first reference image displayed on a display;

FIG. 10 is a diagram for describing a striped pattern having dark and light parts, which generates in a captured image;

FIG. 11 and 12 are diagrams showing the flow of a profile creating process in a printer mode;

FIG. 13 is a perspective view showing an example of the layout of a profile creating system in a display mode;

FIG. 14 is a block diagram showing the functional configuration of a second profile creating unit;

FIG. 15 is a diagram showing an example of a second reference image printed by a printer; and

FIG. 16 is a diagram showing a light reception amount of a CCD in image capturing with flashlight.

### DESCRIPTION OF THE PREFERRED EMBODIMENTS

Hereinafter, preferred embodiments of the present invention will be described with reference to the drawings.

1. Configuration of Profile Creating System

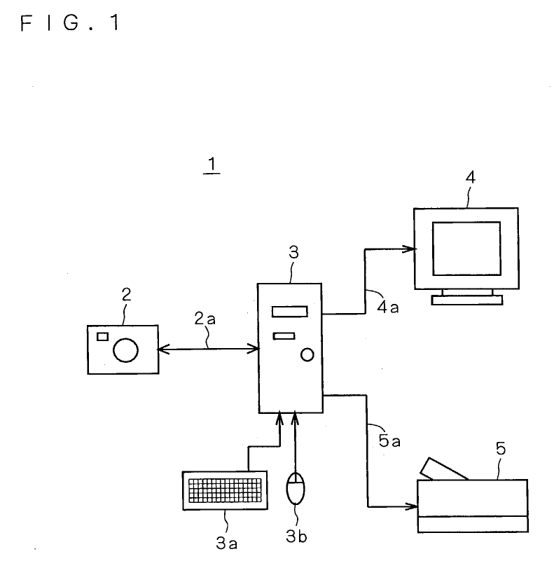

FIG. 1 is a diagram showing the configuration of a profile creating system according to a preferred embodiment of the present invention. A profile creating system 1 has a digital still camera (hereinafter, referred to as “digital camera”) 2 for capturing image data by image capturing, a computer 3, a display 4 and a printer 5. A profile denotes data expressing performance and characteristics of each of input/output devices (in the preferred embodiment, the display 4 and the printer 5) and is data used for performing color correction including color matching in color management. In the preferred embodiment, an ICC profile conformed with an ICC (International Color Consortium) format is created.

The computer 3 is connected to the devices (digital camera 2, display 4 and printer 5) via dedicated cables 2a, 4a and 5a, respectively, and controls the devices. A keyboard 3a and a mouse 3b as operating units for accepting an input from the operator are also connected to the computer 3.

In the profile creating system 1 of the preferred embodiment, on the basis of image data (hereinafter, also properly simply referred to as “image”) captured by the digital camera 2, a profile of the display 4 and printer 5 is created by the computer 3. The profile creating system 1 has, as processing modes for creating a profile (hereinafter, referred to as “creating modes”), a “display mode” for the purpose of creating a profile of the display 4 and a “printer mode” for the purpose of creating a profile of the printer 5. Either the display mode or the printer mode can be selected by the keyboard 3a or mouse 3b.

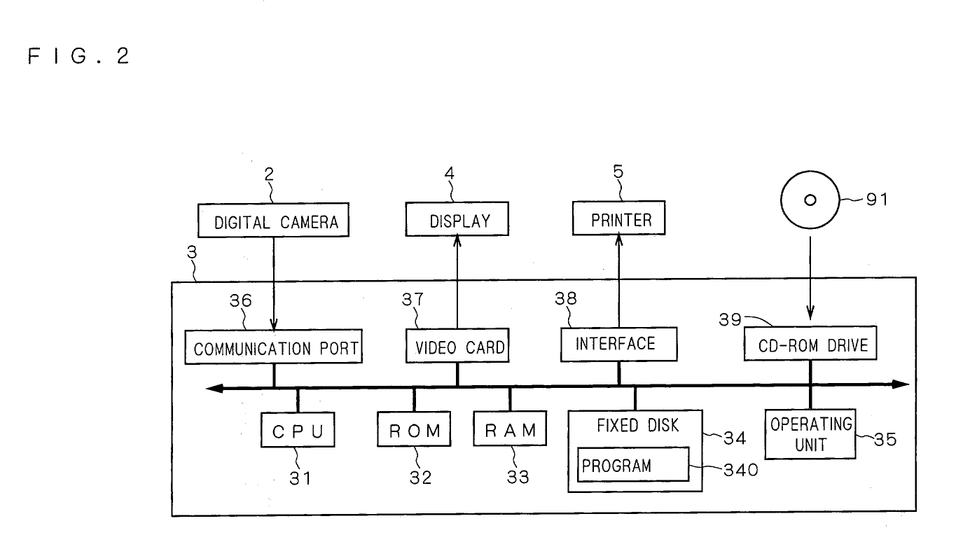

FIG. 2 is a block diagram showing main internal components of the computer 3 together with the digital camera 2 and the like. The computer 3 is a general computer and has a configuration in which a CPU 31 for executing a computing process, a ROM 32 for storing a basic program, a RAM 33 as a storage area for work, a fixed disk 34 for storing various data, and an operating unit 35 (keyboard 3a and mouse 3b) are connected to a bus line.

To the bus line, a communication port 36 for transmitting/receiving information to/from the digital camera 2, a video card 37 for performing a display control of the display 4, a communication interface 38 to the printer 5, a CD-ROM drive 39 for reading a program recorded on a CD-ROM 91, and the like are also connected properly via an interface.

In the fixed disk 34, a program 340 read from the CD-ROM drive 39 and data which is necessary at the time of creating a profile is stored. According to the program 340, the CPU 31 performs an operation while using the RAM 33 as a work area, thereby realizing various functions for creating a profile.

The program 340 may be configured so as to be down-loaded from a predetermined server via a network and stored in the fixed disk 34.

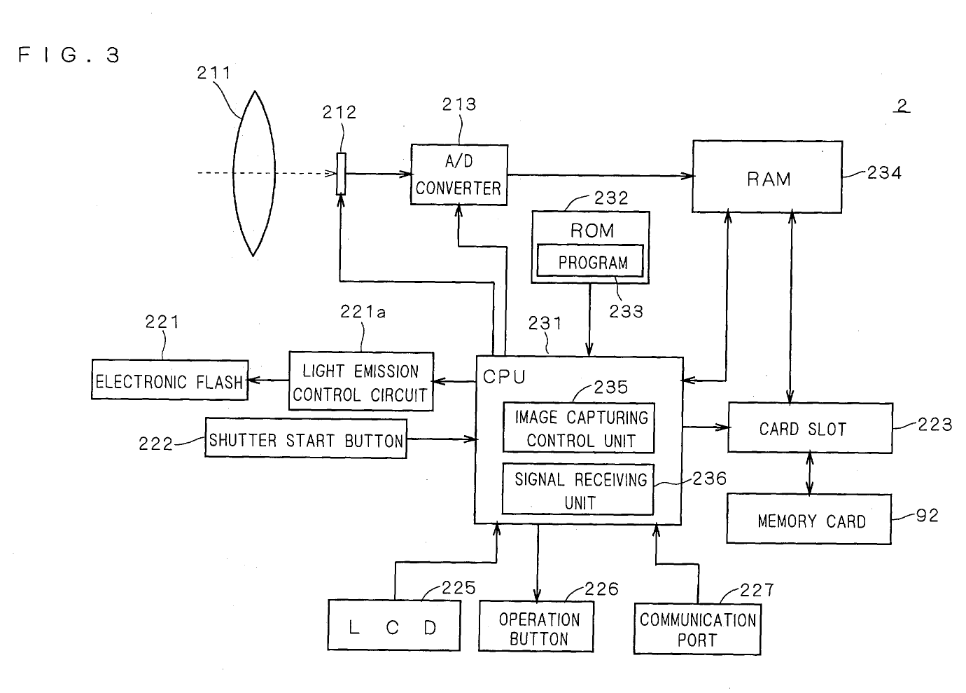

FIG. 3 is a block diagram showing main internal components of the digital camera 2. In the configuration shown in FIG. 3, a lens system 211, a CCD 212, an A/D converter 213, a shutter start button 222, a CPU 231, a ROM 232, and a RAM 234 realize functions of obtaining an image. Specifically, when an image of a subject is formed on the CCD 212 by the lens system 211 and the shutter start button 222 is depressed, an image signal from the CCD 212 is analog-to-digital converted by the A/D converter 213. The digital image signal obtained by the conversion in the A/D converter 213 is stored as captured image data into the RAM 234. The CCD 212 is image pickup part of three bands for obtaining values of colors of R, G and B as values of pixels.

The image capturing processes are controlled by an image capturing control unit 235 as a function realized when the CPU 231 operates according to a program 233 stored in the ROM 232.

In the digital camera 2, an LCD 225 for displaying an image as a viewfinder and displaying various information, an operation button 226 for accepting various operations from the operator, a card slot 223 for transmitting/receiving information to/from a memory card 92 as a detachable external memory, and a communication port 227 for transmitting/receiving information to/from the computer 3 are connected to the CPU 231.

Further, an electronic flash 221 for illuminating a subject is connected to the CPU 231 via a light emission control circuit 221a. When an instruction of making the electronic flash 221 emit flashlight is received from the CPU 231, the light emission control circuit 221 a controls the light emission of the electronic flash 221.

The image capturing control unit 235 controls the image capturing process and makes setting of image capturing conditions before image capturing, concretely, setting of an exposure condition regarding exposure and setting of a light emission/non-emission mode of the electronic flash 221. The exposure control in the digital camera 2 is executed by adjusting a shutter speed (corresponding to exposure time of the CCD 212) and an f-number (the diameter of an aperture included in the lens system 211).

A signal receiving unit 236 shown in FIG. 3 is one of the functions realized when the CPU 231 operates according to the program 233. The signal receiving unit 236 analyzes a signal received from the computer 3 via the communication port 227 and gives an instruction of control regarding image capturing according to the signal to the image capturing control unit 235. With the configuration, by transmitting a predetermined signal to the digital camera 2, the computer 3 can perform the image capturing control of the digital camera 2 from a remote place.

2. Profile Creating Process

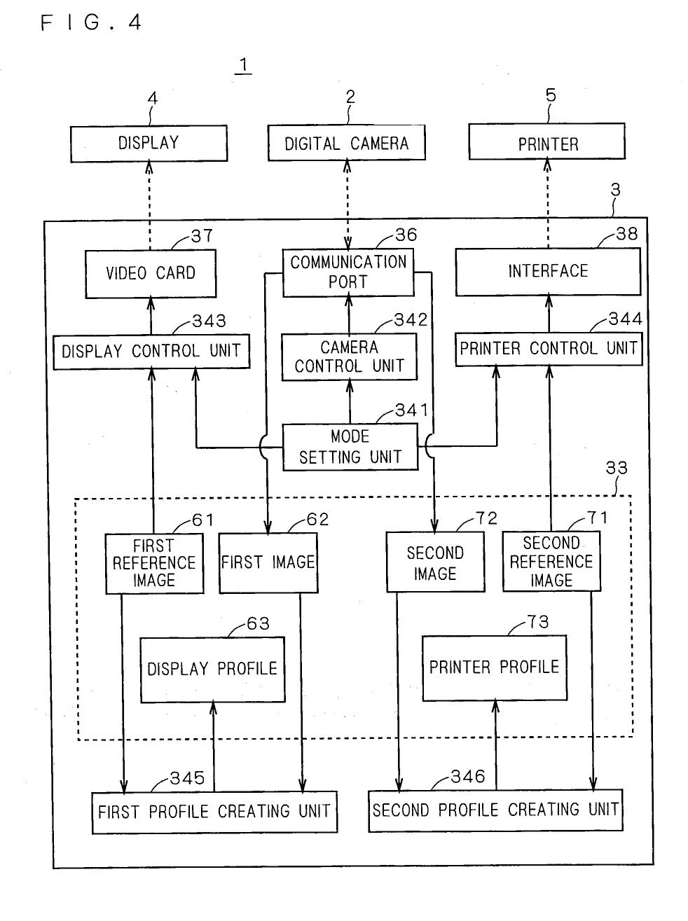

FIG. 4 is a block diagram showing the configuration realized mainly by the CPU 31, RAM 33 and the like of the computer 3 together with the other configuration. In the configuration shown in FIG. 4, a mode setting unit 341, a camera control unit 342, a display control unit 343, a printer control unit 344, a first profile creating unit 345 and a second profile creating unit 346 are functions realized by the CPU 31, ROM 33 and the like of the computer 3. The functions will be described later in detail.

The display control unit 343 includes the functions of a video card driver and a display driver, and the printer control unit 344 includes the function of a printer driver.

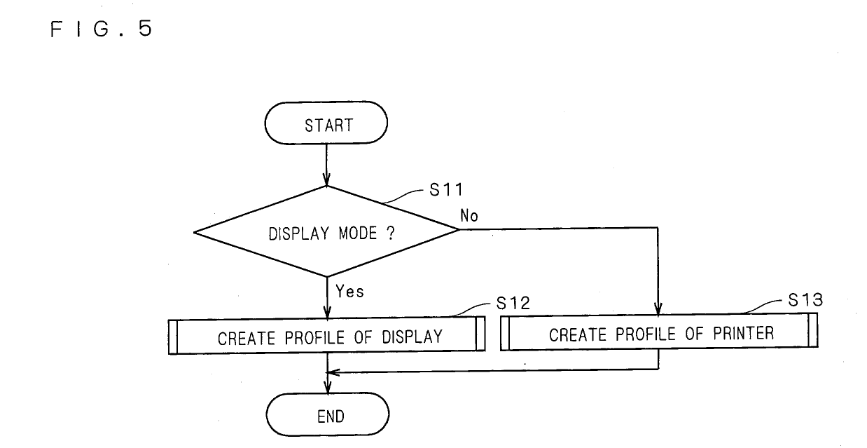

FIG. 5 is a diagram showing the outline of the flow of processes of the profile creating system 1. At the time of creating a profile, first, whether a creating mode preliminarily selected by the operator is the display mode or printer mode is determined by the mode setting unit 341 (step S11). The result of determination is supplied from the mode setting unit 341 to each of the camera control unit 342, display control unit 343, printer control unit 344, first profile creating unit 345 and second profile creating unit 346. In response to it, each of the processing units performs a process according to the selected creating mode.

Specifically, when the selected generating mode is the display mode, a process of creating a profile 63 of the display 4 (hereinafter, referred to as “display profile”) is performed (step S12). When the selected generating mode is the printer mode, a process of creating a profile 73 of the printer 5 (hereinafter, referred to as “printer profile”) is performed (step S13). The details of processes in the display mode and the printer mode will be described later.

2-1. Creation of Profile of Display

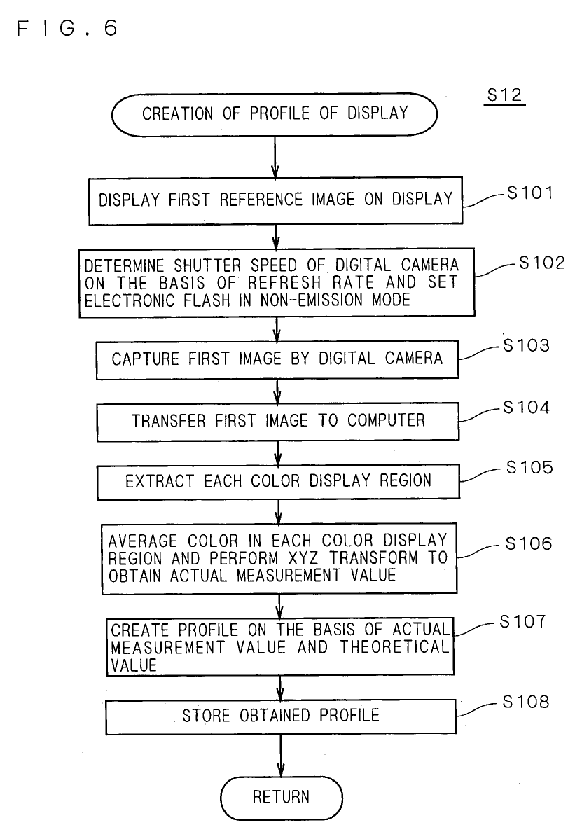

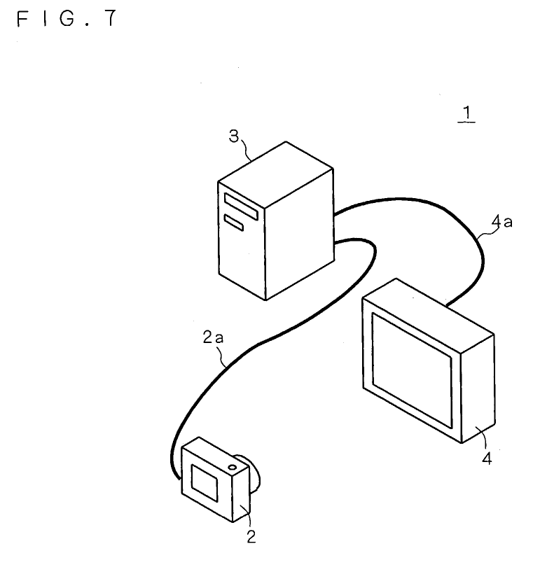

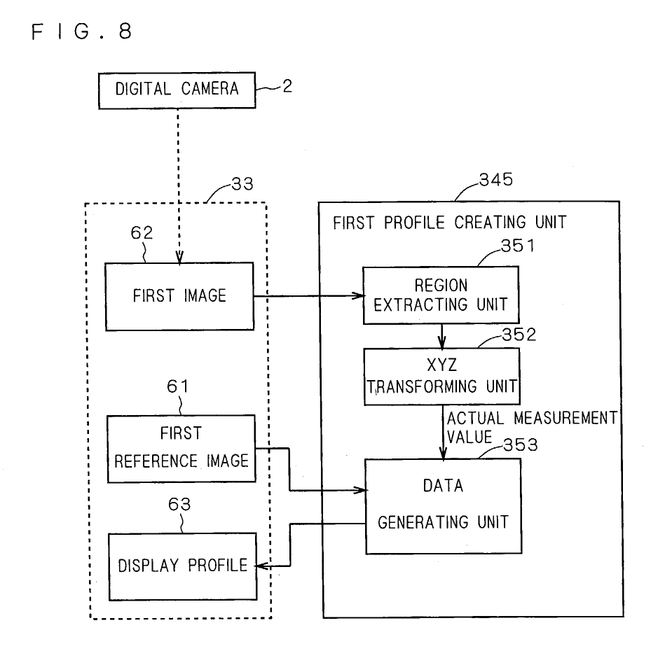

FIG. 6 is a diagram showing the flow of a profile creating process in the display mode (step S12 in FIG. 5). FIG. 7 is a perspective view showing an example of layout of the profile creating system 1 (in which the printer 5 is not shown) in the display mode. FIG. 8 is a block diagram mainly showing the functional configuration of the first profile creating unit 345. With reference to FIG. 4 and FIGS. 6 to 8, processes for creating the display profile 63 of the profile creating system 1 will be described later.

First, under control of the display control unit 343 of the computer 3, according to a first reference image 61 prestored in the RAM 33, an image signal is transmitted to the display 4 via the video card 37 and displayed on the display 4 (step S101).

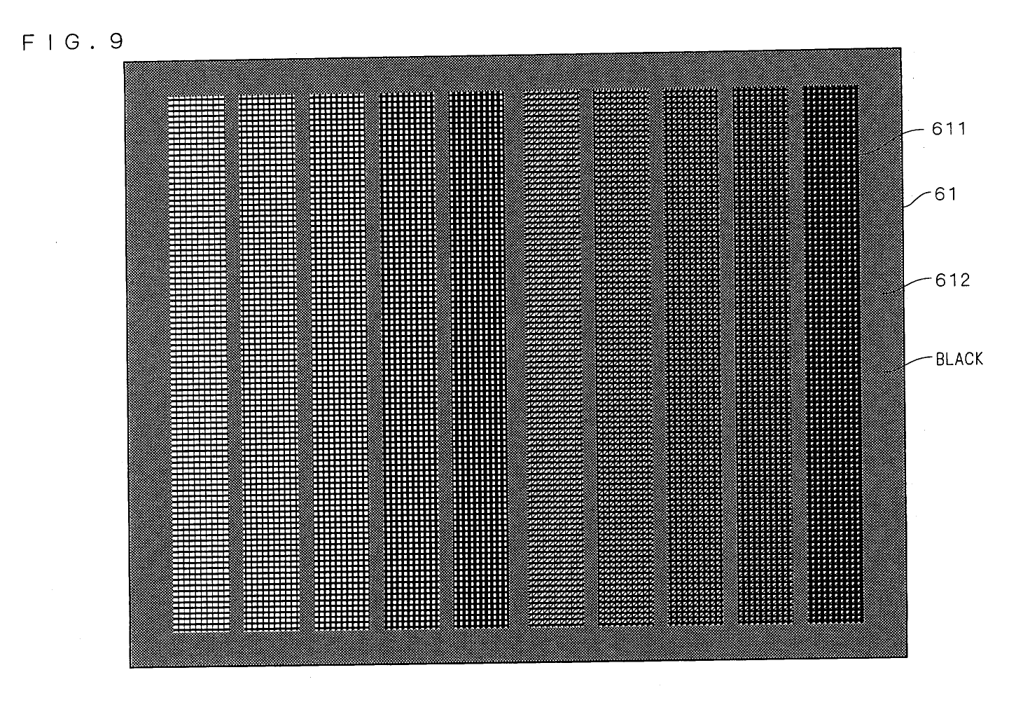

FIG. 9 is a diagram showing an example of the first reference image 61 displayed on the display 4. FIG. 9 artificially expresses color display by using hatching. The first reference image 61 is an image in which a plurality of rectangular color display regions 611 each having a longitudinal direction in the vertical direction of the screen (perpendicular direction) are disposed in the lateral direction of the screen (horizontal direction). In the color display regions 611, colors of color components of RGB which are different from each other are displayed. A peripheral region 612 for partitioning the color display regions 611 is displayed in black.

Next, image capturing conditions of the digital camera 2 are set on the basis of the control of the computer 3. In the setting, the shutter speed of the digital camera 2 is set to time based on a refresh rate (vertical scan frequency) of the display 4.

Concretely, the refresh rate of the display 4 is inputted from the display control unit 343 to the camera control unit 342 of the computer 3. The shutter speed of the digital camera 2 is determined by the camera control unit 342 on the basis of the refresh rate.

In the preferred embodiment, when the refresh rate of the display 4 is RR (Hertz) and the shutter speed is SS (seconds), the shutter speed SS is determined as follows.

SS=(1/RR)×10 (Equation 1)

Since the refresh rate is used to indicate how many times the whole screen of the display 4 is updated per second, the shutter speed is determined to time equal to or longer than time in which the screen of the display 4 is updated ten times. In other words, the shutter speed is determined to time which is ten times as long as the time required to update the screen (inverse of the refresh rate: hereinafter, referred to as “screen updating period”) or more.

Generally, in a display employing a CRT as a display device, a tube screen on which phosphors of RGB are applied is irradiated with an electron beam, and the phosphors glow by the energy of the electron beam to thereby display screen information. The electron beam can make only one point in the screen glow each time and the phosphor glows only a moment. Consequently, when the screen is scanned with an electron beam from the upper left of the screen to the upper right and scan of one line (horizontal scan line) is finished, the next lower line is scanned from the left end. Such an operation is repeated at high speed from the top of the screen to the bottom, thereby displaying information on the whole screen.

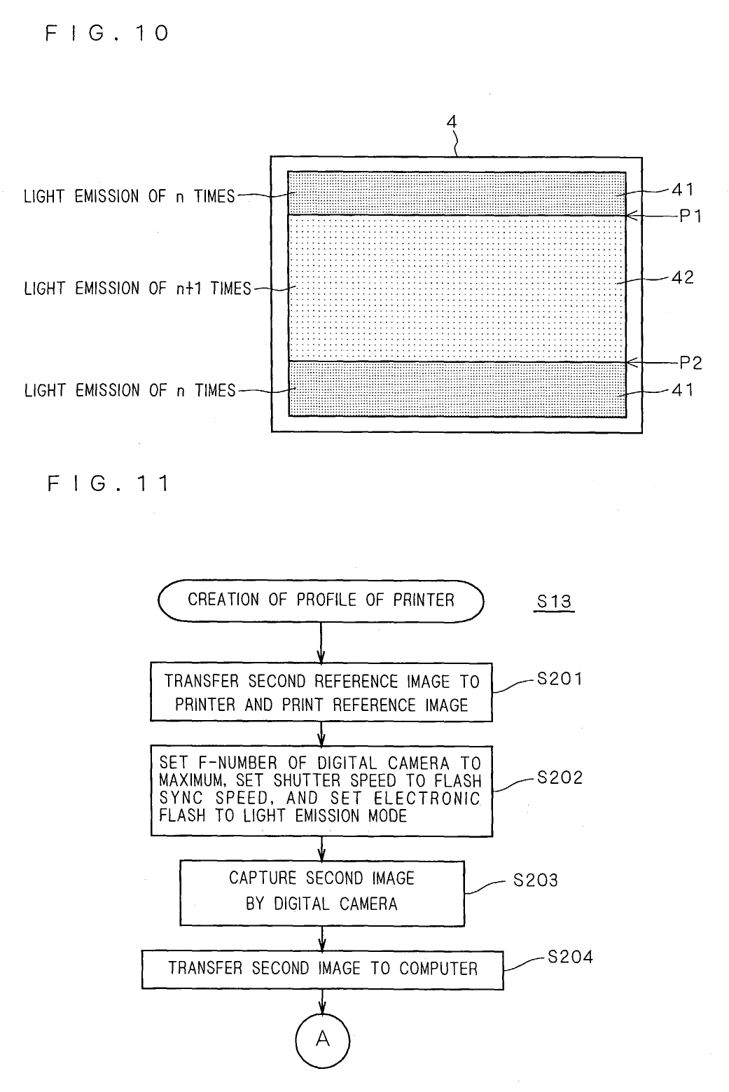

Therefore, in an image captured by capturing an image of the screen of the display 4 by the digital camera 2, as shown in FIG. 10, the luminance in a region 41 in which a phosphor glows n times and that of a region 42 in which a phosphor glows (n+1) times are different from each other, and a striped pattern of dark and light portions (color unevenness) occurs. In FIG. 10, a reference numeral P1 denotes a horizontal scan line which emitted light at the start of exposure, and a reference numeral P2 denotes a horizontal scan line which emitted light at the end of exposure.

The luminance variations in the stripped pattern which occurs in a captured image decrease as the number of updating times of the screen of the display 4 during exposure of the digital camera 2 increases. By setting the number of updating times to, preferably, ten times or more, the striped pattern can be made relatively inconspicuous. In the profile creating system 1, the shutter speed of the digital camera 2 is set to ten times of the screen updating period or more, so that the striped pattern of dark and light parts can be reduced in a captured image.

The determined shutter speed is transmitted as a signal to the digital camera 2 via the communication port 36 by the camera control unit 342, and the shutter speed of the digital camera 2 is set on the basis of the signal.

Further, it is controlled by the camera control unit 342 so that the exposure condition of the digital camera 2 is set by the shutter speed priority (only the f-number is adjusted while fixing the shutter speed), and the electronic flash 221 is set in the no-emission mode (step S102).

Next, the first reference image 61 displayed on the screen of the display 4 is captured by the digital camera 2 under the set image capturing conditions (electronic flash: no-emission, and shutter speed: screen updating period×10 or longer). The captured screen of the display 4 is stored as a captured image (hereinafter, referred to as “first image”) into the RAM 234 of the digital camera 2 (step S103). The image capturing operation may be started on the basis of a signal from the computer 3 or when the operator operates the shutter start button 222.

In the case where a number of color display regions 611 are provided in order to increase the precision of a profile, step S103 may be performed a plurality of times. Specifically, it is also possible to sequentially display the plurality of first reference images 61 of which colors to be displayed are different from each other on the display 4 and to obtain a first image 62 using the digital camera 2 plural times.

At the time of capturing an image, as shown in FIG. 7, the digital camera 2 and the display 4 are disposed so that an image pickup screen of the digital camera 2 and the screen of the display 4 become parallel to each other, the optical axis of the digital camera 2 and the center of the screen of the display 4 coincide with each other, and the whole screen of the display 4 lies within the viewfinder of the digital camera 2.

The obtained first image 62 is recorded on the memory card 92 via the card slot 223 and is also transferred to the computer 3 via the communication port 227, dedicated cable 2a and the communication port 36 of the computer 3 and stored in the RAM 33 of the computer 3 (step S104).

In the computer 3 in which the first image 62 is transferred to the RAM 33, the display profile 63 is created by the first profile creating unit 345 on the basis of the first reference image 61 and the first image 62 (steps S105 to S107).

In the computer 3, first, each of the color display regions 611 in the first image 62 is extracted by a region extracting unit 351 (step S105). Since the color display regions 611 are partitioned by the black peripheral region 612, rectangular regions partitioned by black color are recognized. Further, in each of the recognized color display regions 611, a region properly reflecting the color of the color display region 611 is obtained as a region to be computed later on.

Since a striped pattern of dark and light portions generates more or less in a captured image as described above, the colors of pixels in the color display region 611 become irregular even in the color display region 611 of the same color. Consequently, by extracting only a region properly reflecting the color of each color display region 611 and using it as an object to be computed later on, a profile of higher precision can be created.

The striped pattern of dark and light portions generates in any of regions in the vertical direction of an image and the region is not fixed but varies every image capturing operation. However, since the first reference image 61 is displayed so that the longitudinal direction of each of rectangular color display regions 611 coincides with the vertical direction of the screen, even if a stripped pattern generates in any of the regions in the vertical direction of an image, a region reflecting the color of each of the color display regions 611 always exists. Therefore, only this proper region is extracted.

Concretely, each color display region 611 recognized is divided into a plurality of regions in accordance with luminance, and attention is paid only to a region having a predetermined area or larger among the plurality of divided regions. The region having the maximum luminance among the regions to which attention is paid is used as a region to be computed.

After the region to be computed in each color display region 611 is extracted, an average value of each of RGB colors of all of pixels in the region to be computed is obtained by an XYZ transforming unit 352 and, further, the obtained average value of each of the RGB colors is transformed to tristimulus values (XYZ values) in the XYZ standard calorimetric system by predetermined matrix computation. In a matrix used for the transformation, characteristics (particularly, a spectral transmission characteristic of a color filter) of the CCD 212 are considered. By the operation, the values of the color representing each color display region 611 in the first image 62 are obtained as values which do not depend on the characteristics of the digital camera 2. The obtained values of the color (tristimulus values) are actual measurement values (step S106).

The matrix used for the transformation is created on the basis of a result of measurement of various displays and prestored in the RAM 33 or the like in the computer 3. Therefore, a matrix matching a color displayed on a display is used. The matrix may be changed according to the hue of the color display region 611 to be transformed. For example, if the amount of components of R is relatively large in pixel values of the color display region 611 to be transformed, a matrix specialized in the R component is used. In such a manner, the color of the color display region 611 can be transformed to XYZ values with high precision.

The actual measurement values are obtained as described above. On the other hand, a theoretical value of the color of each color display region 611 is specified by a data generating unit 353 on the basis of the first reference image 61. Specifically, with respect to each of the color display regions 611 in the first reference image 61, color information (XYZ values or the like as the base of the RGB values) outputted from the computer 3 to the display 4 is specified. The process may be performed at an arbitrary stage between steps S101 and S106.

After the actual measurement value and the theoretical value of color information of each color display region 611 are obtained, data of the display profile 63 is generated by the data generating unit 353 by using the values. To be specific, a table in which the actual measurement value and the theoretical value are associated with each other is created. With reference to the table, in conformity with the standard of the ICC profile, XYZ values of each of the RGB colors, a tone reproduction curve (that is, a γ curve) of each color, and the like are created. In such a manner, data used for correcting the display color of the display 4 is created, and a profile storing the data is finally created as the display profile 63 (step S107).

After that, the created display profile 63 is overwritten on an existing profile or stored under different name (step S108). In the case of displaying an arbitrary color on the display 4, the created display profile 63 is used to determine a value of a signal to be generated by the computer 3.

2-2. Creation of Profile of Printer

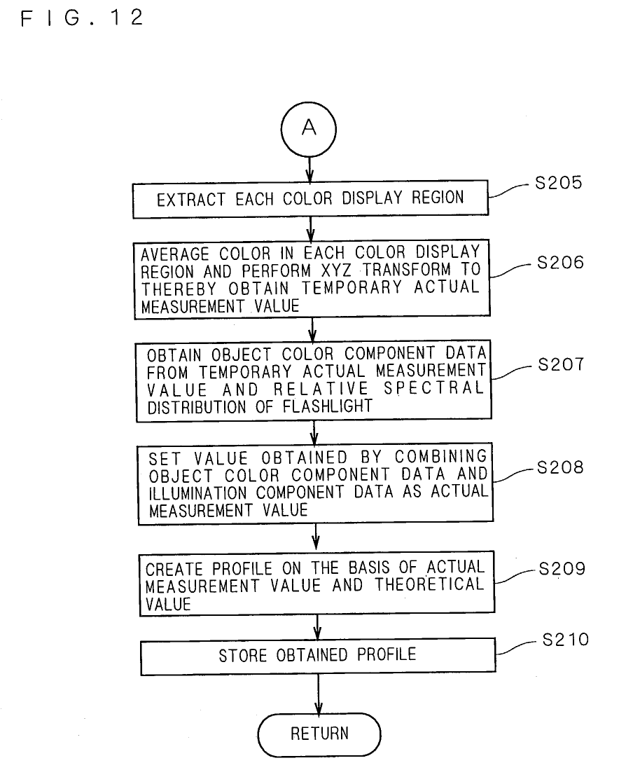

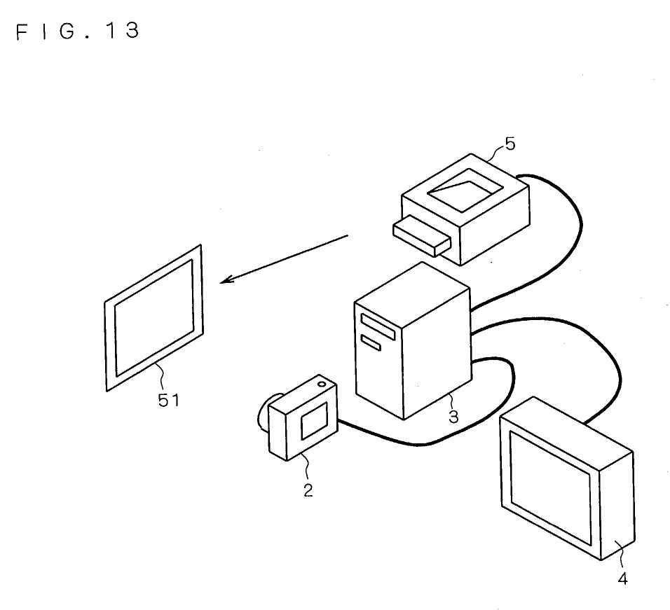

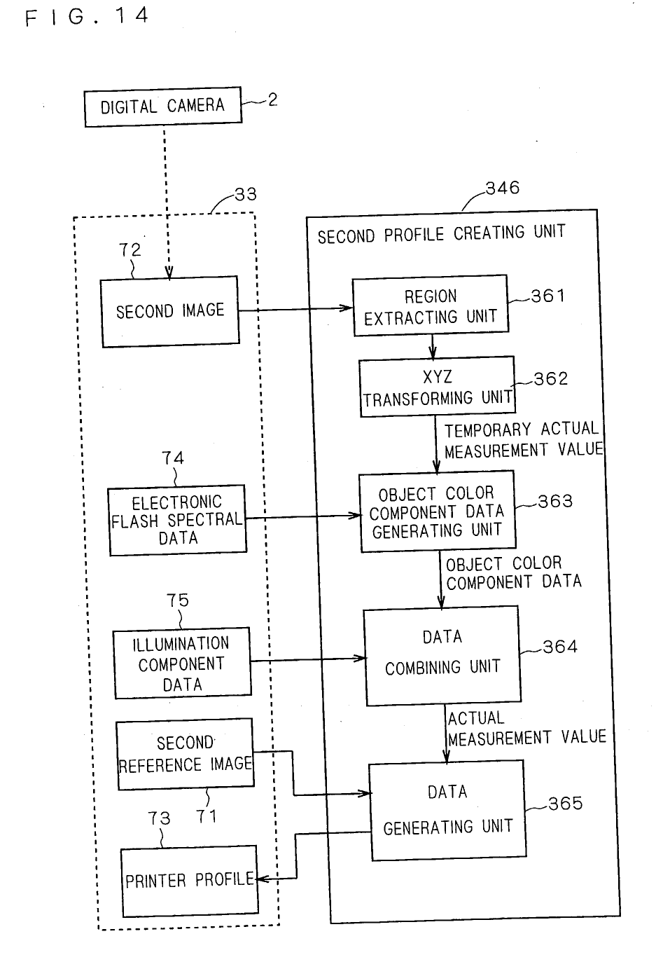

The printer mode will now be described. FIGS. 11 and 12 are diagrams showing the flow of the profile creating process (step S13 in FIG. 5) in the printer mode. FIG. 13 is a perspective view showing an example of the layout of the profile creating system 1 in the printer mode. FIG. 14 is a block diagram showing the functional configuration of the second profile creating unit 346. With reference to FIG. 4 and FIGS. 11 to 14, the process for creating the printer profile 73 in the profile creating system 1 will be described.

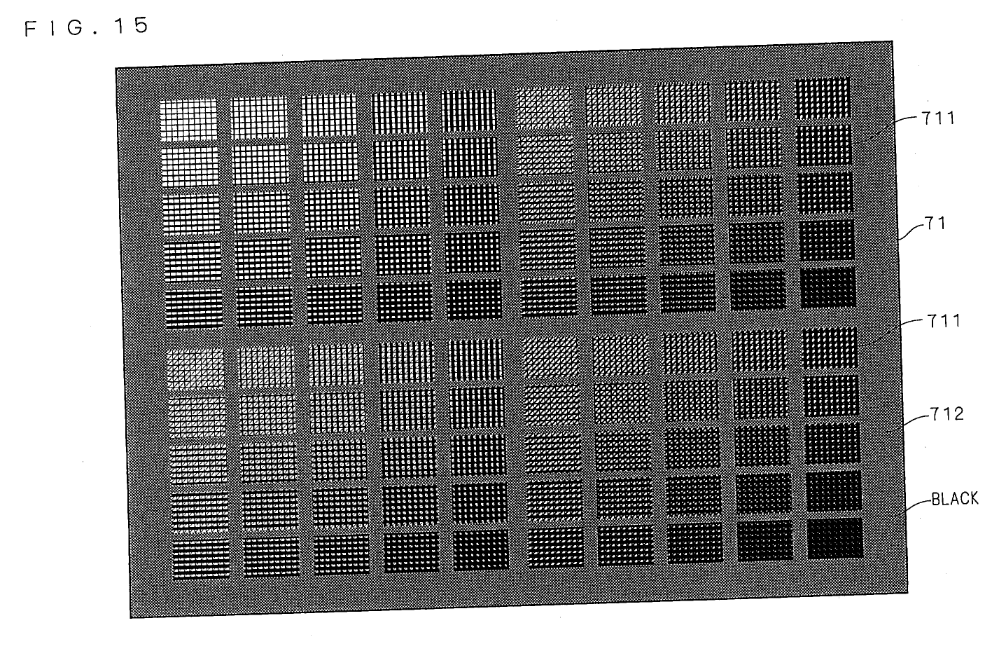

First, under control of the printer control unit 344 of the computer 3, according to a second reference image 71 prestored in the RAM 33, an image signal is transmitted to the printer 5 via the interface 38, and the printer 5 prints an image on a sheet 51 of paper (step S201). By the operation, the second reference image 71 illustrated in FIG. 15 is printed on the sheet 51.

FIG. 15 artificially expresses color display by using hatching. The second reference image 71 is an image in which a plurality of rectangular color display regions 711 each of which is relatively smaller than each of the color display regions 611 in the first reference image 61 are disposed in the vertical and horizontal directions. In the color display regions 711, colors whose components of CMY (cyan, magenta and yellow) and black are different from each other are printed and displayed. A peripheral region 712 partitioning the color display regions 711 is printed and displayed in black. FIG. 15 shows just an example of the second reference image 71. Alternately, to increase the precision of the profile, a plurality of second reference images 71 of different colors may be printed.

After completion of printing of the second reference image 71, image capturing conditions of the digital camera 2 are set on the basis of control from the camera control unit 342 in the computer 3. Concretely, the electronic flash 221 is set to the light emission mode, the f-number is set to the maximum (the diameter of the aperture is the minimum), and the shutter speed is set to a flash sync speed (highest shutter speed at which the shutter can fully open to perform exposure with flashlight) (step S202).

The sheet 51 on which the second reference image 71 is printed is photographed by the digital camera 2 under the set image capturing conditions (electronic flash: light emission mode, f-number: maximum, and shutter speed: flash sync speed). By the operation, an image (hereinafter, referred to as “second image”) of the sheet 51 irradiated with flashlight is obtained and stored into the RAM 234 of the digital camera 2 (step S203). The image capturing operation may be also started on the basis of a signal from the computer or when the operator operates the shutter start button 222. When a plurality of second reference images 71 exist, while sequentially changing a plurality of sheets 51, a second image 72 is obtained using the digital camera 2 plural times.

At the time of image capturing, as shown in FIG. 13, the digital camera 2 and the sheet 51 are disposed so that the image pickup screen of the digital camera 2 and the sheet 51 are parallel to each other, the optical axis of the digital camera 2 and the center of the sheet 51 coincide with each other, and the whole sheet 51 lies in the viewfinder of the digital camera 2.

In the image capturing, light emission of the electronic flash 221 is controlled to be performed with a predetermined voltage and light emission time by the light emission control circuit 221a, so that the light emission characteristics of the electronic flash 221 do not vary according to the image capturing operations. The spectral distribution of the electronic flash 221 is kept constant by the light emission control. The spectral distribution is preliminarily measured and stored as electronic flash spectral data 74 in the RAM 33. To be accurate, a relative spectral distribution of flashlight (which is a spectral distribution normalized by using the maximum spectral intensity as 1 and will be referred to as “relative spectral distribution” hereinafter) is used as the electronic flash spectral data 74.

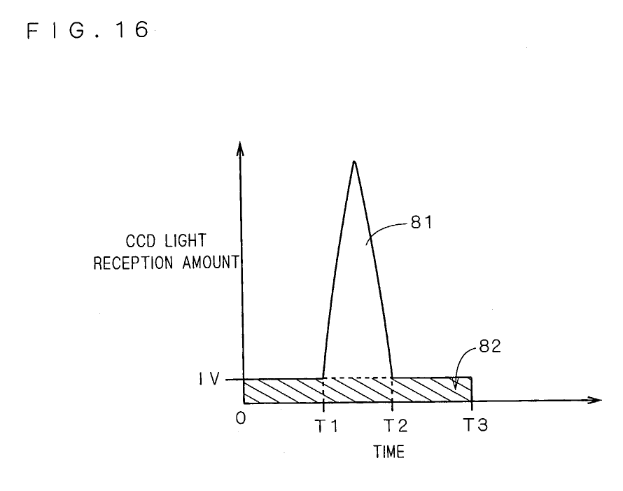

FIG. 16 is a diagram showing a light reception amount of the CCD 212 in the image capturing. In the diagram, the vertical axis indicates the light receiving amount in a pixel in the CCD 212 and the horizontal axis indicates time (exposure time of the CCD 212). The exposure amount of the pixel corresponds to an integral value of the light reception amount with respect to time. Light incident on the CCD 212 is obtained by multiplexing reflection light of the flashlight illuminating the sheet 51 and reflection light of fixed light (illumination light of the periphery). In FIG. 16, the area of a region 82 which is equal to or lower than a value IV corresponds to the exposure amount of the reflection light of the fixed light, and the area of a region 81 exceeding the value IV corresponds to the exposure amount of the reflection light of the flashlight.

After image capturing is started (exposure is started in the CCD 212), at time T1 at which the shutter opens fully, flashlight is emitted from the electronic flash 221. The time of light emission of the electronic flash 221 is controlled to be constant by the light emission control circuit 221a, and the light emission of the electronic flash 221 is finished at time T2. After that, when predetermined exposure time T3 (that is, shutter speed) elapses, the exposure of the CCD 212 is finished.

As described above, the f-number is set to the maximum and the shutter speed is set to the flash sync speed, the amount of incident light on the CCD 212 is regulated, and the exposure amount of reflection light of the fixed light becomes much smaller than that in normal image capturing. Therefore, the captured second image can be regarded as image data obtained only with flashlight as illumination light.

The captured second image 72 is recorded on the memory card 92 via the card slot 223 and is also transferred to the computer 3 via the communication port 227, the dedicated cable 2a and the communication port 36 of the computer 3 and stored in the RAM 33 in the computer 3 (step S204).

In the computer 3 to which the second image 72 is transferred to the RAM 33, the printer profile 73 is created on the basis of the second reference image 71 and the second image 72 by the second profile creating unit 346 (steps S205 to S209 in FIG. 12).

In the computer 3, first, each of the color display regions 711 in the second image 72 is extracted by a region extracting unit 361 (step S205). Since the color display regions 711 are partitioned by the black peripheral region 712, the rectangular regions partitioned by black color are recognized. Further, in each of the recognized color display regions 711, a region properly reflecting the color of the color display region 711 is obtained as a region to be computed later on.

Generally, an image of a subject as a reflector is captured with flashlight, a phenomenon of mixture of colors of pixels in a high-contrast region (color bleeding) occurs in a captured image due to saturation of pixels of high luminance having a high degree of reflection of flashlight, chromatic aberration and the like. For example, when it is assumed that the color of the peripheral region 712 of the second reference image 71 is white having the high degree of reflection of flashlight, the white color of the peripheral region 712 and the color of the color display region 711 are mixed with each other and the color of the color display region 711 cannot be properly obtained.

As described above, since the peripheral region 712 of the second reference image 71 is black in the preferred embodiment, such a phenomenon can be effectively suppressed. However, mixture of the color of the peripheral region 712 and the color of the color display region 711 occurs more or less. Consequently, by extracting only a region properly reflecting the color of each color display region 711 and using it as an object to be computed later on, a very precise profile can be created.

Concretely, since the mixture occurs around the periphery of the color display region 711, pixels included within a predetermined distance from the periphery of the recognized color display region 711 are excluded from the region to be computed.

After the region to be computed in each color display region 711 is extracted, an average value is obtained with respect to each of the RGB values of all of pixels in the region to be computed by the XYZ transforming unit 362. Further, the obtained average value of each of the RGB colors is transformed to tristimulus values (XYZ values) in the XYZ standard calorimetric system by a predetermined matrix computation. In a matrix used for the transformation, characteristics (particularly, a spectral transmission characteristic of a color filter) of the CCD 212 are considered. Therefore, the values of the color representing each color display region 711 in the second image 72 are obtained as values which do not depend on the characteristics of the digital camera 2 (step S206).

The matrix used for the transformation is created on the basis of a result of measurement of the printing results of various printers with flashlight of the electronic flash 221 and prestored in the RAM 33 or the like in the computer 3. Therefore, a matrix (which is different from the matrix used in the display mode) matching a print color of the printer and specialized in the characteristics of the electronic flash 221 is used. In a manner similar to the display mode, the matrix used for transformation may be changed according to the hue of the color display region 711 to be transformed.

In the display mode, the value of the color obtained by the XYZ transforming unit 352 is used as an actual measurement value. In the printer mode, however, since the subject is a reflector, the value is influenced by the color of an illumination environment for illuminating the subject (that is, flashlight) (influenced by the spectral characteristic). Consequently, the obtained value is a temporary actual measurement value (hereinafter, referred to as “temporary actual measurement value”) and the influence of the color of the illumination environment is removed from the temporary actual measurement value by the following process.

First, by using the temporary actual measurement value and the electronic flash spectral data 74, a component obtained by eliminating the influence of the illumination environment from the temporary actual measurement value is computed as object color component data by an object color component data generating unit 363 (step S207). The object color component data is data substantially corresponding to the spectral reflectance factor of the subject. The principle of obtaining the object color component data (spectral reflectance factor of the subject) from the temporary actual measurement value and the electronic flash spectral data 74 as a relative spectral distribution of the flashlight will be described later.

Next, the object color component data is combined with illumination component data 75 by a data combining unit 364, thereby generating an actual measurement value. As the illumination component data 75, a spectral distribution of standard light D50 is used. A spectral reflectance factor of the subject is multiplied by the spectral distribution of the standard light D50 by the data combining unit 364, and values (tristimulus values) of a color of each color display region 711 obtained when the sheet 51 as a subject is illuminated with the standard light D50 are generated as actual measurement values in the computer 3 (step S208).

The actual measurement value is obtained as described above. On the other hand, the theoretical value of the color of each color display region 711 is specified on the basis of the second reference image 71 by a data generating unit 365. Specifically, color information (such as XYZ values as the base of the CMYK values) outputted to the printer 5 are specified with respect to each of the color display regions 711 in the second reference image 71. The process may be performed at an arbitrary stage between steps S201 and S208.

After the actual measurement value and the theoretical value of color information of each of the color display regions 711 are obtained, by using the values, data of the printer profile 73 is generated by the data generating unit 365. Specifically, a table in which the actual measurement value and the theoretical value are associated with each other is created. With reference to the table, in conformity with the standard of the ICC profile, a transform table or the like used for transformation between a device color space and a PCS (Profile Connection Space) is generated. In such a manner, data used for correcting the printing color of the printer 5 is generated, and a profile storing the data is finally created as the printer profile 73 (step S209).

After that, the created printer profile 73 is overwritten on an existing profile or stored under different name (step S210). In the case of printing an arbitrary color on the printer 5, the created printer profile 73 is used to determine the value of a signal to be generated by the computer 3.

The principle of obtaining, as object color component data, data corresponding to the spectral reflectance factor of the subject from the temporary actual measurement value and the electronic flash spectral data 74 in step S207 in FIG. 12 will now be described.

First, when the wavelength of a visible range is set as λ and the spectral distribution of illumination light (illumination light in an illumination environment including light directly from a light source and indirect light) for illuminating the subject is expressed as E(λ), the spectral distribution E(λ) is expressed as follows by using three base functions E₁(λ), E₂(λ) and E₃(λ) and weighted coefficients ε₁, ε₂ and ε₃.

$$E ( λ ) = {\sum }_{i = 1}^{∋} ϵ i E i ( λ ) \qquad ( Equation 2 )$$

Similarly, the spectral reflectance factor S(λ) in a position on the subject corresponding to a pixel (hereinafter, referred to as “target pixel”) is expressed as follows by using three base functions S₁(λ), S₂(λ) and S₃(λ) and weighted coefficients σ₁, σ₂ and σ₃.

$$S ( λ ) = {\sum }_{j = 1}^{∋} σ jSj ( λ ) \qquad ( Equation 3 )$$

In this case, light I(λ) incident on the target pixel on the CCD 212 (incident light in the case where a filter attached to the lens system 211 and the like is ignored) is expressed as follows.

$$I ( λ ) = {\sum }_{i = 1}^{∋} ϵ iEi ( λ ) \cdot {\sum }_{j = 1}^{∋} σ jSj ( λ ) \qquad ( Equation 4 )$$

When tristimulus values of X, Y and Z of the target pixel are set as ρ_{X}, ρ_{Y} and ρ_{Z}, and color matching functions of the XYZ standard calorimetric system are set as R_{X}(λ), R_{Y}(λ) and R_{Z(λ), ρ}_{X}, ρ_{Y} and ρ_{Z} are expressed as follows.

ρ_{X}=∫R_{X}(λ)I(λ)dλ

ρ_{Y}=∫R_{Y}(λ)I(λ)dλ

ρ_{Z}=∫R_{Z}(λ)I(λ)dλ (Equation 5)

That is, when a stimulus value of any of X, Y and Z of the target pixel (hereinafter, referred to as “target stimulus value”) is set as ρ_{c} and a color matching function corresponding to the target stimulus value is set as R_{c}(λ), the value ρ_{c} can be expressed as follows.

$$\begin{matrix}{ρ}_{c} = \int {R}_{c} ( λ ) I ( λ ) ⅆ λ \\ = \int {R}_{c} ( λ ) \cdot {\sum }_{i = 1}^{∋} ϵ iEi ( λ ) \cdot {\sum }_{j = 1}^{∋} σ iSi ( λ ) ⅆ λ \\ = {\sum }_{i = 1}^{∋} {\sum }_{j = 1}^{∋} ϵ i σ j \{ \int {R}_{c} ( λ ) Ei ( λ ) Sj ( λ ) ⅆ λ \}\end{matrix} \qquad ( Equation 6 )$$

In Expression 6, the base functions Eᵢ(λ) and Sᵢ(λ) and the color matching function R_{c}(λ) are predetermined functions. The information is prestored in the ROM 32 and the RAM 33. Since the second image 72 corresponds to an image obtained with only flashlight as illumination light, the weighted coefficient εᵢ can be derived from a relative spectral distribution of flashlight by a method which will be described later.

The unknown values in Equation 6 are, therefore, three weighted coefficients σ₁, σ₂ and σ₃ only. Equation 6 can be obtained with respect to each of three stimulus values ρ_{X}, ρ_{Y} and ρ_{Z} in the target pixel. By solving the three equations, the three weighted coefficients σ₁, σ₂ and σ₃ can be computed. That is, the spectral reflection factor of the subject in the position corresponding to the target pixel can be obtained.

A method of obtaining the weighted coefficient εᵢ will now be described. As mentioned above, the second image 72 corresponds to an image obtained with only flashlight as illumination light, and the relative spectral distribution of illumination light in the second image 72 is known. On the other hand, the degree of receiving flashlight in a region on the subject far from the electronic flash 221 is lower as compared with a region close to the electronic flash 221. Therefore, in the second image 72, the farther the position from the electronic flash 221 is, the darker the image becomes.

However, in the case of capturing an image of the sheet 51, the distance from the digital camera 2 to the sheet 51 can be regarded as constant, so that it can be considered that the intensity of flashlight is uniform in the whole sheet 51. It is also possible to store characteristics of the flashlight distribution and lens aberration and correct an image in accordance with the characteristics. The weighted coefficient εᵢ is a value preliminarily obtained by measurement.

On the basis of the principle, the spectral reflectance factor on the sheet 51 corresponding to the target pixel can be obtained from the tristimulus values of the target pixel and the electronic flash spectral data 74. In reality, the object color component data generating unit 363 uses, not the tristimulus values of a pixel, but a temporary actual measurement value corresponding to an average value of the tristimulus values of a pixel in each of the color display regions 711. Consequently, an average spectral reflectance factor is obtained in a position corresponding to the color display region 711 on the sheet 51, and the obtained data is used as object color component data (step S207).

After the object color component data is obtained, by executing computation shown by Equation 6 by the data combining unit 364 as described above, the tristimulus values of the color display region 711 obtained when the sheet 51 is illuminated with the standard light D50 are obtained as actual measurement values (step S208).

In Equation 6, ρ_{c} is any of tristimulus values of a color representing a color display region 711, ε₁, ε₂ and ε₃ are three weighted coefficients expressing a spectral distribution of standard light, and σ₁, σ₂ and σ₃ are three weighted coefficients expressing an average spectral reflectance factor in a position corresponding to the color display region 711 on the subject.

As described above, the profile creating system 1 has the display mode and the printer mode and creates a profile of the display or printer on the basis of an image obtained by the digital camera 2 in accordance with the selected creating mode. Therefore, proper profiles of both the display and printer can be created by a single system, and an expensive dedicated measurement device is not required to create each of the profiles of the display and printer, so that the cost can be suppressed low. Further, since profiles of both of the display and printer can be created, color matching between the display and printer can be carried out properly.

Since the image capturing conditions of the digital camera 2 are set according to the selected creating mode, an image according to a processing mode which is required to create a profile can be easily obtained.

3. Modifications

The above described preferred embodiment has described that the image capturing conditions of the digital camera 2 are set on the basis of a signal from the computer 3. It is also possible to store image capturing conditions adapted to create profiles of the display and printer as image capturing modes in the digital camera 2 and select an image capturing mode in accordance with a device for creating a profile by the operator.

In this case, the computer 3 and the digital camera 2 do not have to communicate with each other. A captured image may be transferred to the computer 3 by using the memory card 92 or the like. With the configuration, the digital camera 2 for creating a profile can be realized by a simple specification change of a digital camera having a CCD provided with a general on-chip filter without requiring a special mechanism.

In the above described preferred embodiment, the computer 3 and each of the devices are connected to each other via a dedicated wired cable to transmit/receive various signals, image data and the like. It is also possible to transmit/receive various signals, image data and the like by wireless communication.

In the above described display mode, although an influence of fixed light in the image capturing is not mentioned, to be strict, when fixed light is incident on the screen of the display 4, due to an influence of the spectral characteristic of the fixed light, display colors of the screen may become uneven. Consequently, in order to increase the precision of a profile, preferably, incidence of the fixed light on the screen of the display 4 is prevented by attaching a hood so as to surround the display 4 or, in the case where the fixed light is light from an artificial light source, turning off the artificial light source. Since the screen of the display 4 is made of an emitter, even if there is no fixed light, image capturing can be performed.

In the above described printer mode as well, when the fixed light at the time of image capturing is light from an artificial light source, it is preferable to prevent the sheet 51 from being illuminated with fixed light by, for example, turning off the artificial light source.

Although the above described preferred embodiment has been described on assumption that the peripheral region 712 partitioning the color display regions 711 of the second reference image 71 is black, the peripheral region 712 may be gray of low luminance, which is achromatic. In this case as well, the degree of reflectance of flashlight can be lowered, and a phenomenon in which colors of pixels in a high-contrast region are mixed can be suppressed. Alternately, it is also possible to prepare a frame in which a portion corresponding to the color display region 711 is open and a portion corresponding to the peripheral region 712 is black, print the peripheral region 712 in the second reference image 71 in a white state by the printer 5, add a frame to the result of printing and, after that, perform image capturing.

It is preferable, from the viewpoint of increasing versatility, to create an ICC profile conformed with the ICC format as a profile in the above described preferred embodiment. Obviously, a profile conformed with a dedicated format may be created.

Although the preferred embodiment has been described that various functions are realized when the CPU executes computation in accordance with a program, all or a part of the computing process may be realized by a dedicated electric circuit. Particularly, by configuring a portion in which computation is performed repeatedly by a logic circuit, high-speed computation is realized.

Although the above described preferred embodiment employs a matrix for converting RGB values to XYZ values in order to eliminate influences of the properties of the digital camera 2 from an image to be computed (the first image 62 or the second image 72), the present invention is not limited to such description. For example, influences of the properties of the digital camera 2 can alternatively be eliminated from an image to be computed based on information which indicates the properties of the digital camera 2 such as the ICC profile thereof and is previously stored in the computer 3.

Although the above description of the preferred embodiment is directed to a display employing a CRT as a display device, another type of display such as a liquid crystal display and a plasma display can alternatively be used for creating a profile in the same manner as described above.

While the invention has been shown and described in detail, the above described description is in all aspects illustrative and not restrictive. It is therefore understood that numerous modifications and variations can be devised without departing from the scope of the invention.

What is claimed is:

1. A program product comprising a computer executable program for creating a profile, said computer executable program comprising:
a selecting instruction for selecting one of a first processing mode and a second processing mode;
a first profile creating instruction operable in said first processing mode to create a profile of a display based on a first captured image obtained by capturing a predetermined first reference image displayed on said display by using a digital image capture device; and
a second profile creating instruction operable in said second processing mode to create a profile of a printer based on a second captured image obtained by capturing an image of a printed matter printed by a printer in accordance with a predetermined second reference image by using said digital image capture device.

2. The program product according to claim 1,
said computer executable program further comprising
an image capture device control instruction for controlling image capturing of said digital image capture device in accordance with a processing mode selected by said selecting part.

3. The program product according to claim 2, wherein
said image capture device control instruction is operable in said first processing mode to control said digital image capture device so as to perform exposure for a time determined based on a screen updating period of said display when said digital image capture device captures said first reference image.

4. The program product according to claim 2, wherein
said image capture device control instruction is operable in said second processing mode to control said digital image capture device so as to achieve an exposure condition which suppresses an incident light amount and to allow flashlight to be emitted toward said printed matter when said digital image capture device captures said printed matter, and
said second profile creating instruction is operable in said second processing mode to obtain object color component data corresponding to data of an image from which an influence of an illumination environment is removed based on said second captured image and a relative spectral distribution of said flashlight, and to create a profile of said printer based on said object color component data.

5. A program product comprising a computer executable program for creating a profile, said computer executable program comprising:
a selecting manager for selecting one of a first processing mode and a second processing mode for creating respective profiles of a display and a printer, respectively;
a first profile taking manager for taking a first captured image obtained by capturing a predetermined first reference image displayed on said display by using a digital image capture device, when said first processing mode is selected;
a first profile creating manager for creating said profile of said display based on said first captured image;
a second profile taking manger for taking a second captured image obtained by capturing an image of a printed matter printed by a printer in accordance with a predetermined second reference image by using said digital image capture device, when said second processing mode is selected, and
a second profile creating manager for creating said profile of said printer based on said second captured image.

6. A profile creating system for creating a profile, comprising:
a selecting part for selecting one of a first processing mode and a second processing mode;
a first profile creating part operable in said first processing mode to create a profile of a display based on a first captured image obtained by capturing a predetermined first reference image displayed on a display by using a digital image capture device; and
a second profile creating part operable in said second processing mode to create a profile of a printer based on a second captured image obtained by capturing an image of a printed matter printed by said printer in accordance with a predetermined second reference image by using said digital image capture device.

7. A method of creating a profile comprising the steps of:
(a) selecting one of a first processing mode and a second processing mode for creating respective profiles of a display and a printer, respectively;
(b) causing a predetermined first reference image to be displayed on said display in said first processing mode;
(c) taking a first captured image obtained by capturing said predetermined first reference image as displayed by using said digital image capture device;
(d) creating said profile of said display based on said first captured image;
(e) causing said printer to print a predetermined second reference image in said second processing mode;
(f) taking a second captured image obtained by capturing said predetermined second reference image as printed by using said digital image capture device;
(g) creating said profile of said printer based on said second captured image.

8. The method according to claim 7,
said step (c) including the step of:
controlling said digital image capture device so as to perform exposure for a time determined based on a screen updating period of said display when said digital image capture device captures said first reference image.

9. The method program product according to claim 7,
said step (f) including the step of:
controlling said digital image capture device so as to allow flashlight to be emitted toward said predetermined second reference image when said digital image capture device captures said predetermined second reference image, and
said step (g) including the step of:
creating said profile of said printer based on said second captured image and a relative spectral distribution of said flashlight.

10. The method program product according to claim 9,
said step (g) including the step of:
obtaining object color component data corresponding to data of an image from which an influence of an illumination environment is removed based on said second captured image and a relative spectral distribution of said flashlight, to create said profile of said printer based on said object color component data.
